(19) United States
(12) Patent Application Publication
(10) Pub. No.: US 2018/0260759 A1
(43) Pub. Date: Sep. 13, 2018

(54) Segmentation of Images

(71) Applicant: Mighty AI, Inc., Seattle, WA (US)

(72) Inventors: Matthew Justin Von Bencke, Bellevue, WA (US); Daryn Edward Nakhuda, Bainbridge Island, WA (US); Angela Beth Hugeback, Bainbridge Island, WA (US); Yuan Li, Bellevue, WA (US); Peter VanTuyl Bentley, Seattle, WA (US); Joseph Delovino Sunga, Seattle, WA (US); Aaron Matthew Hedquist, Seattle, WA (US); Matthew Cameron Herz, Seattle, WA (US)

(21) Appl. No.: 15/914,416

(22) Filed: Mar. 7, 2018

Related U.S. Application Data
(60) Provisional application No. 62/489,402, filed on Apr. 24, 2017.
(60) Provisional application No. 62/468,235, filed on Mar. 7, 2017.

(51) Int. Cl. G06Q 10/06; G06T 7/10

(52) U.S. Cl. CPC G06Q 10/063112; G06T 7/10; G06Q 10/063114; G06Q 10/06398

(57) ABSTRACT

Disclosed is a configuration for segmenting an image. For each user, the configuration computes an accuracy and contribution score. The configuration determines multiple tasks for segmenting an image. For each task, the configuration assigns a particular user to work on a task based on an accuracy or a contribution score of the particular user, receives an indication of a completed task from the particular user, and assesses an accuracy of the completed task based on the accuracy of the particular user. Responsive to determining all multiple tasks are completed accurately, the configuration combines the completed multiple tasks to form a segmented image.

### CROSS REFERENCE TO RELATED APPLICATIONS

This application claims the benefit of U.S. Provisional Application No. 62/489,402, filed Apr. 24, 2017 and U.S. Provisional Application No. 62/468,235, filed Mar. 7, 2017, both of which are incorporated by reference in their entirety.

### TECHNICAL FIELD

The disclosure generally relates to using multi-input sources to solve large data problems, and more specifically, automation for assignment of tasks. In addition, the disclosure relates to accessing the accuracy of completed tasks.

### BACKGROUND

Multi-input sources, e.g., crowdsourcing, is one solution to solve a large data problem by breaking it into smaller tasks that may be completed by an individual. Once the smaller tasks are completed by individuals, the large data problem will be completed. A problem with using crowdsourcing to solve large data problems is that the smaller tasks may not be completed correctly, and thus, the large data problem will not be completed correctly. One such large data problem can be image segmentation, in which an image is divided into labeled parts.

It often is desirable to obtain and analyze a very large number of data points in order to have normalized or expected values of data. However, obtaining the large number of data points comes at a cost. For example, having input received quickly to achieve normalized or expected data may be impractical as the input from the crowd may not be received quick enough. Moreover, the input from the crowd may be imprecise and may cause deviations that consume even more time to move back towards normalization or expected values.

To increase speed of input from the crowd, in some instances the crowd may be compensated. However, the costs of this input can be cost prohibitive. For example, this requires a large compensation commitment to compensate the crowd for their input. Moreover, even with the compensation, the results may still be unacceptable or outside of what are expected data points. Hence, in addition to being cost prohibitive, there is a waste of time and resources for data points that are unusable.

Further, there are issues with manually pairing individuals and tasks to be completed within short time frames. This process also may be time consuming, inefficient, and costly. If received data is not analyzed quickly to determine whether it is within a proper margin of expected results, the data ultimately may be unusable and require redoing the tasks.

In addition, it is difficult to assess the accuracy of completed tasks, as the assessment of accuracy may be based on subjective criteria, complex criteria, or criteria that is difficult to assess consistently across different reviewers. A variety of additional factors, such as ambiguous instructions, difficult questions and human cognition patterns (e.g., “groupthink”) may also produce consensus around incorrect and/or suboptimal answers, thereby producing a deceptive illusion of accuracy.

### SUMMARY

Described is a configuration that may include a system, a method, and/or program code storable on a non-transitory computer readable storage medium, to determine computerized tasks in a task batch for assignment to a plurality of entities, e.g., users. The configuration determines multiple tasks for segmenting an image and/or other tasks. For each task, the configuration assigns a user to work on a task based on an accuracy or a contribution score of the user, receives a completed task from the user, and assesses an accuracy of the completed task. Responsive to determining all multiple tasks are completed accurately, the configuration combines the completed multiple tasks to form a segmented image. The configuration may determine an accuracy of the user based on a number of previously completed tasks by the user that did not require modification by another user and a number of previously completed tasks by the user that were assessed for accuracy. The configuration may determine a contribution score of the user based on an input job progress metric and an output job progress metric of previously completed tasks by the user that were assessed for accuracy. The configuration may also include user interface (UI) features to facilitate the segmentation of images such as shared outlines, showing prior work, directionality of images, and a configurable toggle button.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 illustrates a block diagram of an example tasking system, according to one or more embodiments.

FIG. 2 is a flow chart diagram for an example workflow of an example tasking system, according to one or more embodiments.

FIGS. 3A and 3B are examples of a user interface used with pre-segmenting an image.

FIG. 4 is an example of recursion to outline cars in an image.

FIG. 5 is an example of a tag team of multiple users to outline an image.

FIG. 6 is an example workflow for segmenting a video.

FIG. 7 is an example of a task refinement workflow, according to one or more embodiments.

FIG. 8 is an example of the linear functional form for a contribution parameter.

FIG. 9 is an example workflow involving recursion and refinement.

FIG. 10 is an example user interface for a user to indicate directionality in an image.

FIG. 11 is an example user interface for a configurable toggle button.

FIG. 12 is an example of different classes of features to be segmented.

FIG. 13A is an example interface show to users of the system regarding training tutorials and qualification of tasks.

FIG. 13B is a close up of the example shown in FIG. 13A.

FIG. 14 is an example of a user outlining a single vehicle.

FIG. 15 is an example of a user outlining a sign.

FIG. 16 is an example of a finished result of a semantic segmentation of an image.

FIG. 17 is a block diagram illustrating components of an example machine able to read instructions from a machine-readable medium and execute them in a processor (or controller).

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

With increased excitement around artificial intelligence (AI) and machine learning in recent years, capabilities in automated image annotation are rapidly expanding. Yet even with all of the advancements in the field it remains difficult for an automated algorithm to accurately complete certain tasks. For example, automated algorithms are unable to accurately bound or outline an object (e.g., a pedestrian) in a complex image under varying lighting and weather conditions. In conventional systems, many example annotations (e.g., thousands of annotations, produced by humans) must be provided as inputs in order to train automated models to precisely identify the edges of an object. From there the model is used to produce automated annotations, but any output must be human-validated and checked for errors. Extensive, iterative human inspection and corrections are required until the model has collected enough information to allow it to reliably produce accurate annotations. This remains an incredibly challenging problem for companies working in fields such as building autonomous vehicles. Moreover, even as machines are eventually trained to reliably solve one problem, there will be new problems that humans would like machines to be able to solve and those new problems will require human-annotated training data and then human validation/correction of model output for iterative improvement. Hence, the technical challenges will continue to remain in areas such as model training.

Models may be trained using the vast collection of training data and used to produce automated annotations to jumpstart the process and minimizing the amount of actual human-time that is required to get the annotations to the very high level of quality that is needed. Models are also produced to better assist users in drawing annotations by hand. For example, edge detection can allow a drawing tool to closely adhere the outline to the actual edges of the object.

Computers will always have limitations as to what they are able to produce without human input, and therefore human input will always be required. The disclosed configuration allows collection of the human input at scale to improve computing operations, for example, in terms of processing accuracy, speed, and application.

The following describes a configuration to achieve high-quality, fully-segmented images utilizing effort across a broad base of users. Segmentation is the process of dividing 100% of an image into labeled (or “semantic”) parts. In one embodiment, once a user action is taken to identify an area of an image or an object within an image completely, a system automatically asks the user to label the object they have outlined and subsequently assigns an ‘Other’ label to the rest of the image either within the view of the user or in a way that the user cannot see and be confused by the ‘Other’ label. Computer vision models utilize the resulting semantic segmentation masks to “learn” to identify objects and their precise contours, thereby enabling a number of commercial applications (e.g., assisted and/or autonomous navigation; retail search, recommendation and association; directory metadata classification; and context-relevant display advertising).

A processing configuration may be for a tasking system that may include a tasking process, predictive engine, and competence engine. The processing configuration may be structured to interact with two collections of predictive models, workflows and software: the first drives assignment of each micro-task to the individual(s) most likely to complete them effectively (“who,” or “competence engine”), and the second assesses the probability that a given answer is accurate (“what,” or “predictive engine”). The processing configuration may assess the probability that a given answer being correct even when there is no objective “truth,” and without either a gold standard or consensus; and to do so increasingly efficiently within a given workflow and among workflows that the configuration automatically and algorithmically determines to be related.

The configuration may be an automated task batch system that takes tasks through the complete process. That is, the system is capable of assigning the tasks to a set of users, collecting answers for those tasks, evaluating those answers through review and other various automated checks, and finally acceptance of a particular answer for inclusion in the customer's deliverable batch. The system may have an embedded quality assurance (QA) process that ensures that the deliverable will meet a customer's specific accuracy target (e.g. 95% accurate) in real time. The system may have the ability to algorithmically identify, verify and continuously monitor specialists by domain (e.g., golf, fashion, radiology) and task type (e.g., author, analyze sentiment, rate). The system may have automated detection and dynamic blocking of poorly performing users and automated promotion of top performing users to refiner status where they provide guidance to users within the tasking process. The system may have the ability to dial between velocity and cost while keeping quality fixed at the customer's required level of accuracy. The system may have the ability to control task availability and payout based on past, projected, and current user accuracy.

### Tasking System

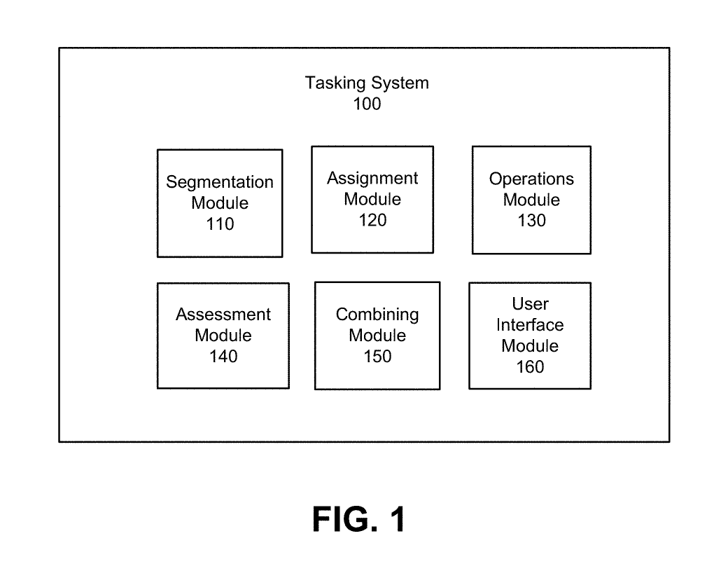

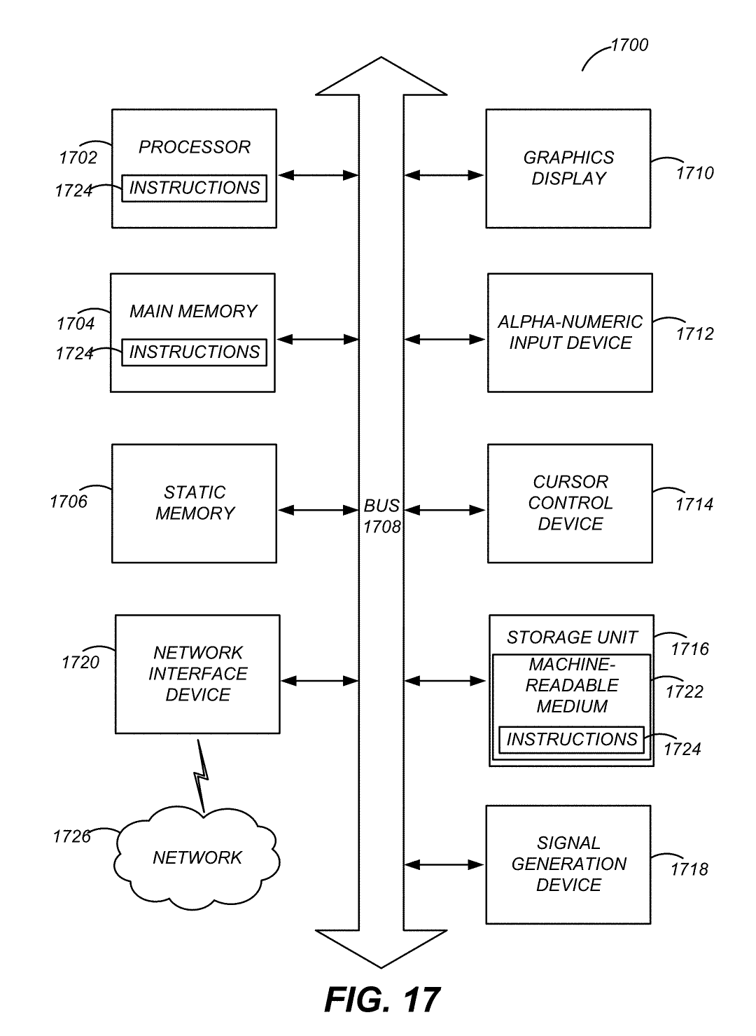

FIG. 1 illustrates a block diagram of an example tasking system 100, according to one or more embodiments. The example tasking system 100 includes a segmentation module 110, an assignment module 120, an operations module 130, an assessment module 140, a combining module 150, and a user interface module 160. Alternative embodiments may include different or additional modules or omit one or more of the illustrated modules. It is noted that the modules may be embodied as program code that corresponds to functionality as described when executed by a computer processing system, e.g., one as described with FIG. 17.

The segmentation module 110 divides a segmentation of an image into multiple tasks. The segmentation module 110 runs through a categorization or tagging process to obtain information about the content of the image. The segmentation module 110 may ask the user to indicate where a type of object exists so that the segmentation module 110 can obtain a count of what types of items are present in the image. In one embodiment, the segmentation module 110 may pre-segment the image by using a color-based edge detection before asking users to indicate on the pre-segmented image where an object exists.

The assignment module 120 assigns tasks to users based on at least one or a combination of the following: the user being qualified for the task, a user accuracy, and a user contribution score. A user may be qualified for the task after successful completion of training (e.g., tutorials) for the task. The concepts of user accuracy and user contribution score are described in more detail in the sections labeled “user accuracy” and “user contribution”.

The operations module 130 manages completion of tasks. The operations module 130 may use recursion to distribute work over a given category. The operations module 130 may use a tag team process to handoff progress between multiple users. The concepts of recursion and tag team are described in more detail in the sections labeled “recursion” and “tag team”.

The assessment module 140 assesses each completed task for accuracy. The assessment of a task uses a refinement process to keep all positive work for a task. The concept of refinement is described in more detail in the section labeled “refinement”.

The combining module 150 merges the completed tasks' results to form a segmented solution to the problem. The merging of the solution may include use of such algorithms described in an “algorithm” section.

The user interface module 160 includes user interface features presented to a user of the tasking system to facilitate the segmentation of images. The user interface module 160 may include features to show a user shared outlines that have been already created or prior work from the user or other users. The user interface module 160 may include a feature for a user to indicate the directionality of an object or a configurable toggle button to retain an array of options with a single click. Features of the user interface module 160 is further described in the section labeled “Tasking System UI”.

### Example Tasking System Workflow

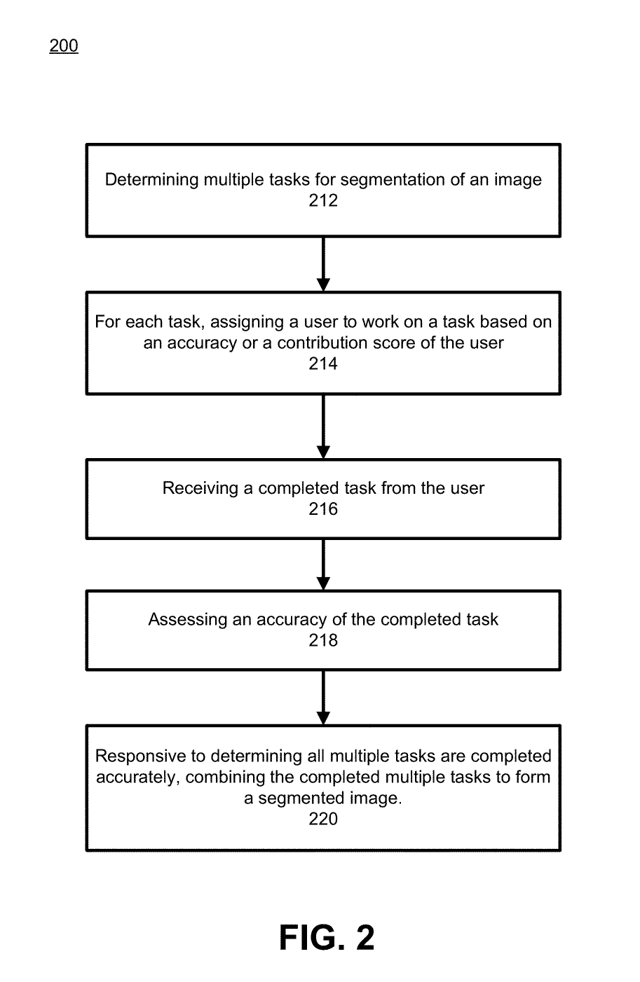

FIG. 2 is a flow chart diagram for an example workflow of the tasking system 100, according to one embodiment. The tasking system 100 determines 212 multiple tasks for segmentation of an image. For each task, the tasking system 100 assigns 214 a user to work on a task based on an accuracy or a contribution score of the user. The tasking system 100 receives 216 a completed task from the user and assesses 218 an accuracy of the completed task. Responsive to the tasking system 100 determining all the multiple tasks are completed accurately, the tasking system 100 combines 220 the completed multiple tasks to form a segmented image.

The process is automated for the purposes of running numerous (e.g., thousands of) images through this process with little manual effort. For example, given a set of images, the images may be run through a categorization or tagging process in order to obtain information about the contents of the images. Users can look at a given image and use either keywording or multi-select to indicate whether cones, pedestrians, or vehicles (etc.) are present within a given image. In one embodiment, users may be instructed to put a dot on each car or each section of vegetation in order to obtain counts about what items are present in the image.

Once items in the image are categorized, the system can begin working through a predefined order of categories. For example, the system may start with a category like vehicles (which from the perspective of a car on the road are often the items which overlap other categories in z-order from the camera's perspective) and instruct users to outline an item in that first category. The system can recurse the image across various users until consensus is reached among multiple users that the image contains no more items within that category to be outlined. Once completion is reached for a category, the system can automatically advance the first image with first category outlines onto the second category, such as road signs, and repeat the process of recursion to complete the outlines for the category.

Once the image has proceeded through the entire catalog of categories, the image can be placed into a final process to achieve polish and ensure (1) that all the elements are outlined and labeled (2) that everything is correctly labeled, and (3) the outlines are accurately drawn. This final process is referred to as the final improvements stage and it works as follows: a first user receives the outlined image which should have a moderate degree of completeness based on having been recursed through the aforementioned categories. The first user observes the outlines compared to the original image to either verify that the image is done or make improvements to either the outlines or labels or both. In one embodiment, refinement may be done after all answers are received. In other embodiments, refinement can be done in different stages of the review process.

### Pre-Segmenting an Image

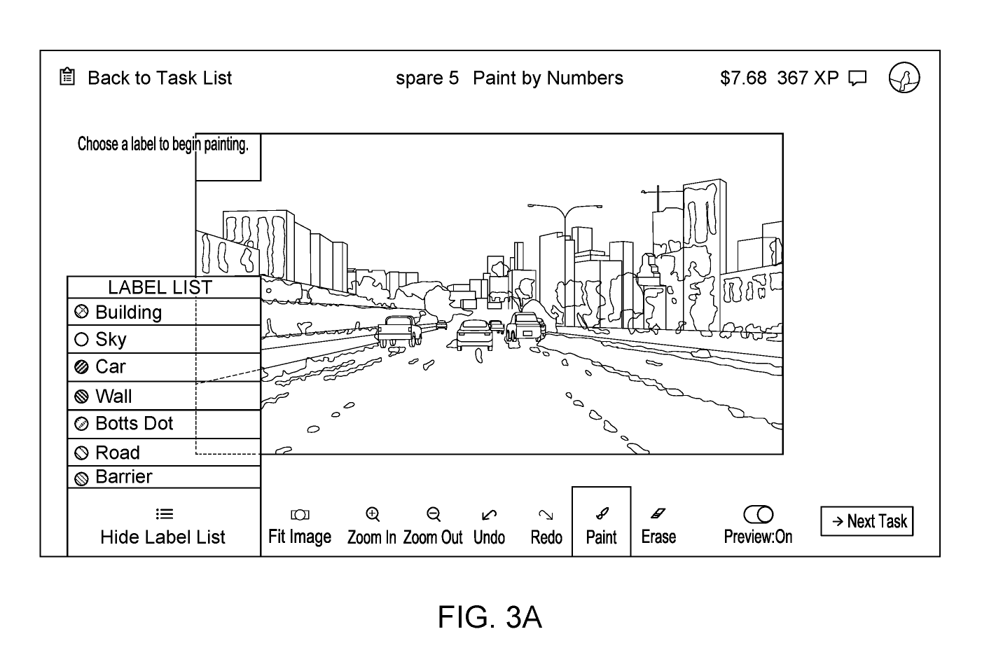

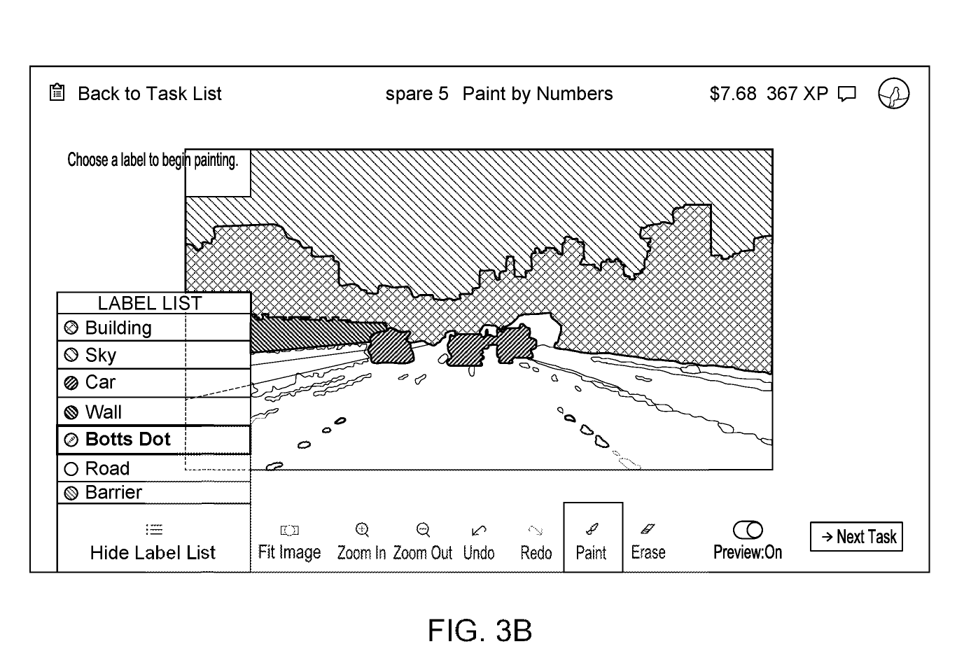

Pre-segmentation refers to a process in which an image is put through a computer process which aims to do a form of edge detection (e.g., grayscale and/or color-based). This process may use open source tools. The process may use polygons to identify and outline shapes of particular objects. Specific configurations for applying polygons are further described below under “Example Algorithms”. Subsequently, users are asked to, instead of outlining each object, indicate with broad strokes where various objects exist within the image. Users are asked to choose an item in the list and then ‘paint’ areas which contain that item. The painted edge expands to fill those shapes which have been defined by the pre-processing. FIGS. 3A and 3B illustrate pre-segmentation of an image.

### Recursion

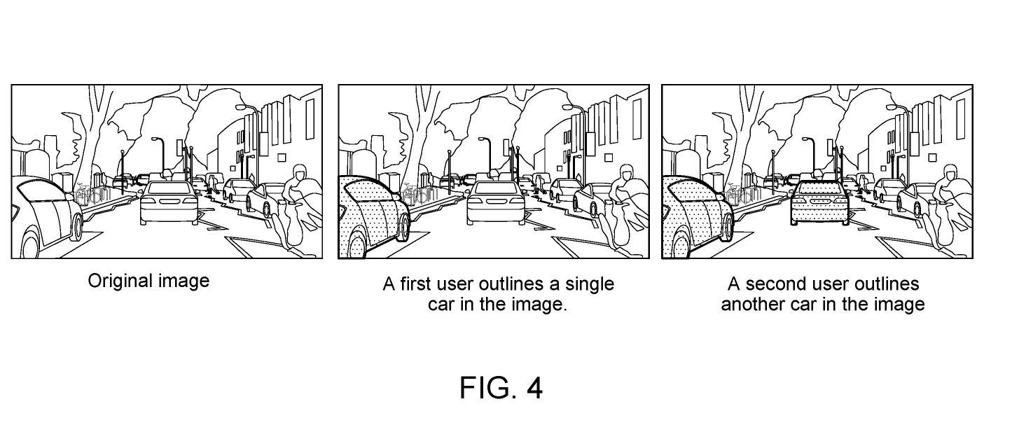

Recursion is the process of distributing work over a given category in order to retain user interest and eliminate fatigue. For example, if an image contains numerous cars, the system may ask users to outline a single car instead of all the cars in the image. After the first user outlines a car the image is then passed to a second user who first answers the question “are there any more cars to outline?” and if they answer in the affirmative then they are allowed to outline another car. FIG. 4 is an example of recursion to outline cars in an image where a first user outlined one car and a second user outlined a second car.

### Tag Team

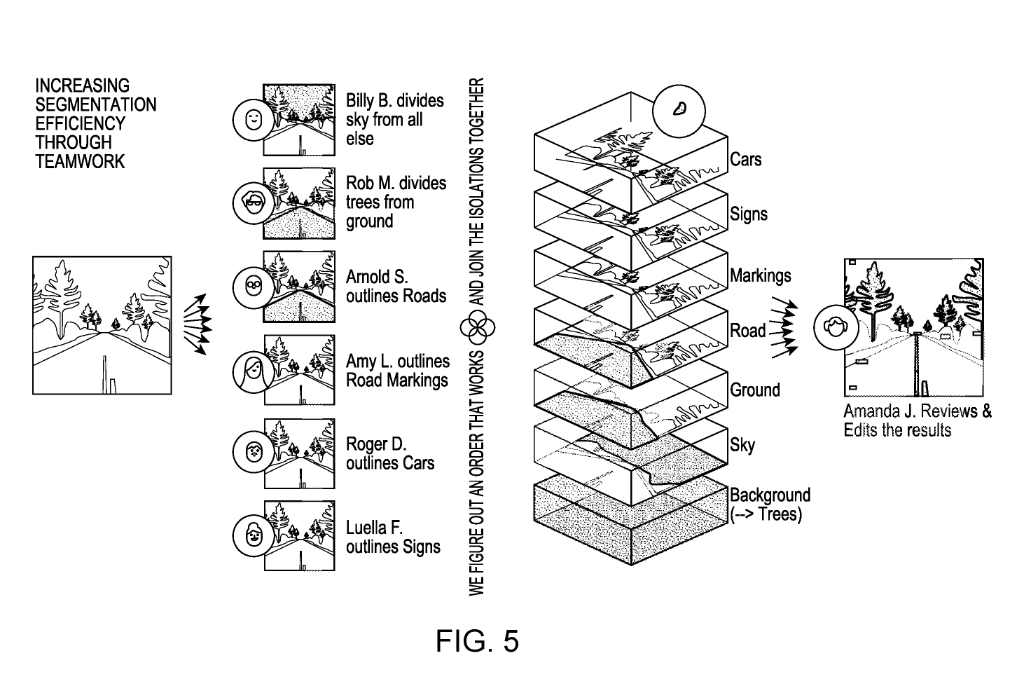

Tag team is the concept of retaining all positive effort made on an image and enabling the handoff of progress between multiple users. Positive effort is defined as any effort which furthers the process of achieving a fully segmented and properly labeled image and is measured by subsequent users who vote by consensus as to whether or not the work done by prior users contributed to the completion of the image or not. There may be a great deal of outlining work to put into an image before it reaches completion. This method enables the system to avoid throwing away work if a given user's effort does not bring the image to 100% completion. If a given user's work brought the image to 90% completion, tag team is the concept of handing that remaining work off to another user so that they can build upon it. FIG. 5 is an example where a tag team of multiple users have outlined an image (illustrated in layers).

### Review Process

When a first user has made a defined number of improvements their work is passed on to a second user who first examines the work that was done (with the new work highlighted against the work that came before) and then makes a judgment as to whether the changes constitute an improvement or not.

If the second user determines that the changes do not constitute an improvement, then the same image may be either passed onto another user in order to gain consensus about the second user's judgment or it may simply be failed and the image in its former state is then passed on to another user in order to either make improvements or pass the image on as complete. If the second user determines that the changes do constitute an improvement then either they or another user are asked whether there are any further improvements to make. If there are further improvements to make then the second user is allowed to make them and the process continues until the images reaches a state where multiple users have confirmed that there are no more improvements to be made to the image.

In later stages of the images, the improvements are small subdivisions of sections which were outlined more broadly by a previous user. Improvements can be made with greater and greater detail and precision depending on the fidelity of the image. Low-resolution, blurry images will only enable a small degree of precision whereas large, high-res images which are complex in nature (involving a maximum number of categories represented) will enable a greater degree of precision with more numerous distinct outlines.

### Concurrent Workstreams

The system can allow one user to do different workstreams at a same time. For example, the system has the ability to have one user do vegetation at the same time as utility poles and have an order by which to merge the outlines into the segmentation (e.g., vegetation before utility poles, and then utility poles “cut out” from vegetation and everything else that's underneath them in z-order). This would use an application order determined ahead of time for combining the different streams of work together into one.

Alternatively the system could determine which things are likely to not overlap (e.g., roads and airplanes) and run those categories concurrently. Since they are unlikely to touch there is no fancy merging that would be necessary.

### Variable Payment

Given that images can take some time to load, limiting the users to outlining only one single object within an image, such as a single dash of a dashed lane line, can be frustrating to users who want to do more with what they have in front of them. In response to this the system has a method of variable payment where the users are asked to outline at least one item in the image, but they are allowed to outline up to a certain number of those items and are paid based on how many they outlined. Keeping this number relatively low (e.g., 5 signs) prevents undesirable fraudulent behavior and reduces the amount of risk taken on per image that users will do fraudulent work.

### Fixing Holes

Toward the end of the process, an image may develop holes (regions where no polygon was drawn and which were unlabeled). The system has a programmatic way to discover these holes and patch them. Based on the determined hole size that was either merged the whole into an adjacent shape (if it was under a certain small size), or routed images with large holes back to the community into a manual cleanup task. Additional details regarding fixing holes is described in the section describing example computing algorithms below, and more specifically example algorithms regarding polygon walk, polygon merger, and hole patcher.

### Ensuring Class Label Consistency in Video

In video, the task may be object tracking. The total length of video is an inhibitor for adoption of the tool. It can be tedious to ensure that a box remains consistently fixed to the outline of an object (e.g., car) for even a short period of time (e.g., 10 seconds). In one embodiment, the task can be divided up among users. For example, a video of a certain length (e.g., 60 seconds) with a variable number of objects (V-Z) can be divided up into numerous cuts (say A-G) so that each community member only tracks an object for a short period of time. When a user is done tracking a single object (e.g., car X) in their cut (e.g., cut 1), their cut gets handed off to another user who tracks another object (e.g., car Y) until all the cars in that cut are done. If all the cars are present at the end of the cut then the next user is given cut B which contains a small final portion of cut 1 so that their task is simply to continue the tracking of car X through the rest of cut 2. This process recurses until all the cars in cut 2 are complete, and cut 3 is then presented to the next user with the final moments of the annotations and tracking from cut 2.

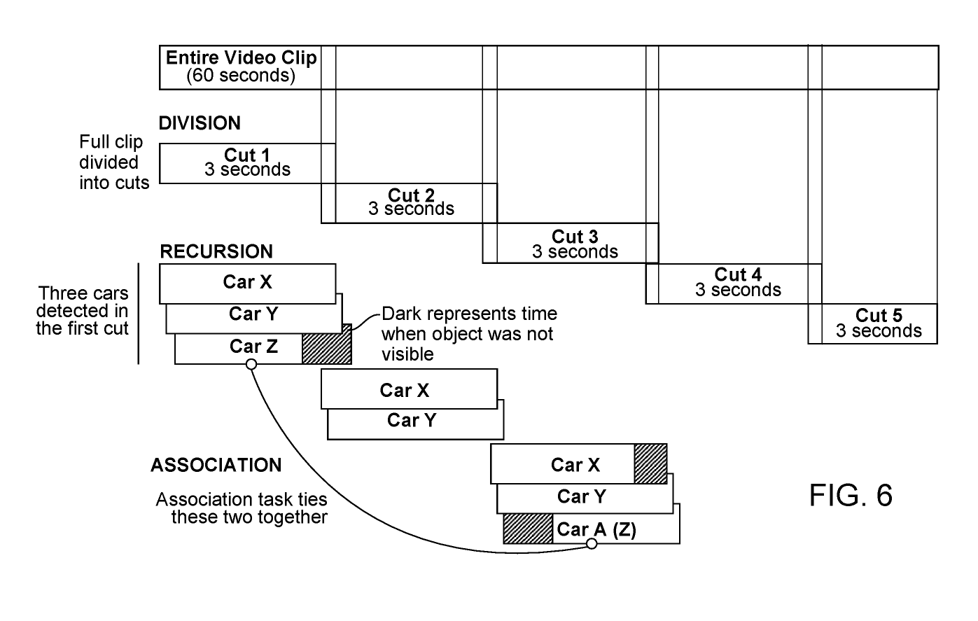

If at any point a car disappears from view within a cut, then neither that bounding box nor that car will be visible to the recipient of the next cut. If a new car Z appears in cut 2 a user can create a new box for this vehicle and label it. Once all the cuts that make up a given clip are complete, all the cuts are passed, assembled together, into a final association task in which another user watches the entire video to ensure that any vehicles which disappeared from view in cut 1 and then reappeared in cut 3 actually get the same label. The final association task involves ensuring consistency of labels across the entire clip. FIG. 6 shows an example of ensuring class label consistency in a video. Such a tasks in video may benefit from use of task refinement, which will be described in the following section.

### Task Refinement

Task refinement is a fully automated system to obtain consistently high quality annotations (or more generally “answers”) from an open community of users. Task refinement can be applied to tasks in which there is a notion of correctness and cases where one user can evaluate another user's answer and potentially make improvements on it. Task refinement can be applied to any type of task on the tasking system such as image annotation, writing, and multiselect. Examples of image annotation tasks include segmentation, bounding boxes, cuboids, tagging, metadata attribution, polylines, keypoints, and others. Examples of writing tasks include writing text such as a phrase, sentence, or paragraph to describe an image or concept. Other examples of tasks may include transcribing speech or other audio (e.g., writing guitar “tabs”), identifying instances of a certain type of object or other aspect in an image (e.g., clicking on points in the image), and identifying frames in a video where a type of event is occurring.

In task refinement, a user submits an initial answer to a question in the source batch. The answer then moves through a dynamic number of “refinement” passes where high-quality users (called “refiners”) are asked to fix the answer if any errors are present. The system automatically determines when a particular answer has received enough refinements to ensure that the quality of the work is such that the overall customer quality goals will be met.

The task refinement system includes many aspects of a “general review” quality system in which one or more reviewers assess whether or not a task is correctly completed, but brings dramatic improvements in the following areas: (1) reduces the total human time required to obtain a correct answer (reducing cost), (2) eliminates multiple iterations on the same job (no need to re-draw the same work), and (3) allows users to do more complex work in one pass because the work can be fixed by refiners when small errors are present.

An example job under a general review process without task refinement is as follows.
Source: Box every kangaroo in the image
Review: Did they correctly box every kangaroo? Yes/No
Source→Review→Review→TOSS
Source→Review→TOSS
Source→Review→Review→TOSS
Source→Review→Review→Review→ACCEPT

An example job under the task refinement process is as follows.
Source: Box every kangaroo in the image
Refinement: Ensure that every kangaroo is correctly boxed
Source→Refine→Refine→Refine→ACCEPT

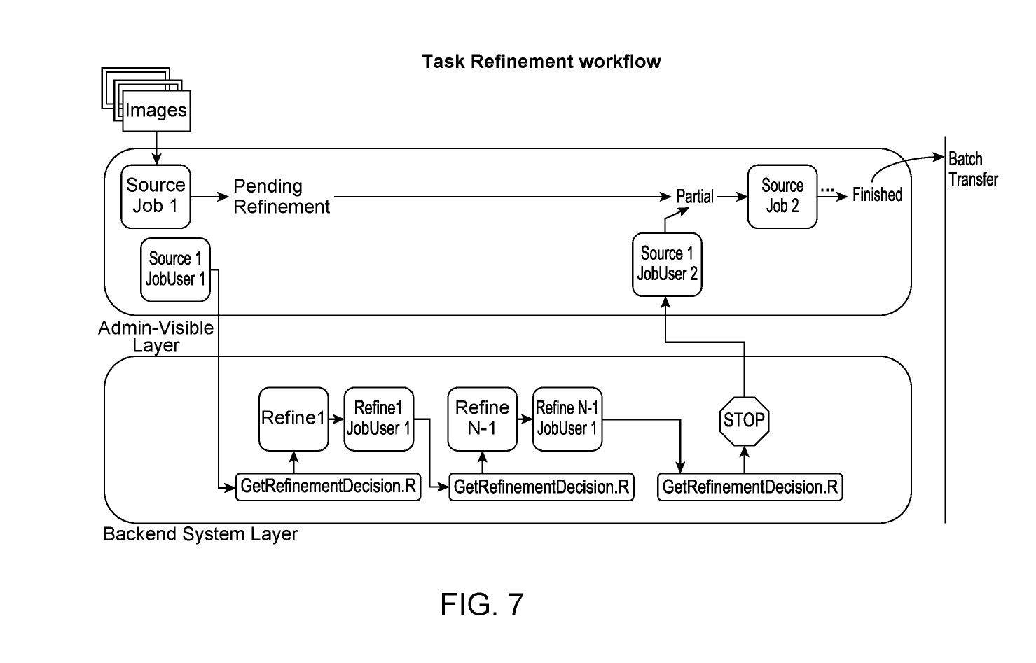

FIG. 7 shows the task refinement workflow. A piece of media (e.g., an image) is passed in to the system. A source job is created for that image. The source job contains a question or instruction that will be asked of the user, such as “Draw a box around each vehicle in the image.” The source job is served out to a user who submits an answer. An answer provided by a user on a specific job is called a JobUser. The following steps are repeated until the job is finished: (1) The system makes a call to the getRefinementDecision code that returns a decision on whether to obtain a refinement on this answer or not. This decision is based on the stopping rule which will be described in detail in a later section. (2) If the code returns “yes, more refinement is needed”:

A new refinement job is generated based on this answer. The refinement job is served out to a refiner. The refiner first evaluates the answer and identifies any errors that are present. If any errors were identified the refiner is asked to fix the errors by editing the original answer. The selection of identified errors along with the (potentially modified) answer is collected in a refinement jobuser. A copy of the resulting answer is collected as a new jobuser in the source batch. (3) If the code returns “no, more refinement is not needed”: The answer is accepted and the job is marked as finished.

In one embodiment, a copy of the final answer is inserted as a final “stub” source job which represents the answer that will be delivered to the customer.

The piece of media (image) can now be transferred on to the next batch set if needed (e.g., “now that all vehicles are boxed, move on to collecting boxes around pedestrians in a separate set of batches”)

### Recursive Batches

Some types of annotations are so complex that they are broken into smaller components for users to work on. For example, rather than asking the user to box every car that appears in the image, the system may ask the user to box just one car in a task and build the complete answer in an iterative fashion. This implementation is called a recursive task. Note that in FIG. 7 the original source job moves in to the partial state before a second source job is collected and finally it is marked as finished at the end. This is to represent recursive tasks which are only partially complete until all iterative answers have been collected. A non-recursive task batch would not use the partial state and instead all jobs would move straight to the finished state,

In the task refinement system jobs in the source batch are open to any user with access to perform the particular type of task. Users who work in the source batch will be asked to take the first pass at providing a correct answer to the question.

Jobs in the refinement batch are only open to users who have a history of consistently strong performance on past task sets. In the refinement batch users are required to improve an answer to the point where they believe the answer is entirely correct. The user should be comfortable claiming the entire answer (including anything originally provided by the source user which remains in the answer) as their own work because they will be evaluated on the full answer that they submit.

### Ensuring Quality Via Task Refinement

High quality annotations are obtained through a variety of automated mechanisms that will be described in greater detail below.

### User Accuracy

The system calculates an accuracy metric for every user within each batch of tasks that the user participates in. The user's accuracy is the proportion of times that the user's answers in a batch were subsequently passed by the refiner who received it. An answer is considered to have passed the refinement if the refiner identifies no errors and therefore chooses to make no modifications to the answer before passing it along. The correctness of the user's job is considered binary and the decision that the refiner makes, either making a modification or passing it along without modification, deems the original answer as either correct or incorrect. A binary measure will not always reflect reality (e.g., a refiner may make a very minor and unnecessary change to perfectly good work) but this approach works well in the long run.

Accuracy is calculated in an identical fashion for both source users and refinement users.

$$Accuracy = \frac{num\_jobs \_that \_passed}{num\_jobs \_that \_were \_evaluated}$$

If the stopping rule (described in a later section) was triggered and the system did not generate any further refinement on a particular answer that a user had provided, then that answer would not have been “evaluated” and therefore the job would ignored for the purposes of calculating accuracy.

### Example

Suppose User A is working in the source batch and User B and User C are working in the refinement batch, and suppose they each touch a particular job. User A submits the original answer, then User B performs a refinement on that answer, and finally User C performs a refinement on User B's answer (which is perhaps User A's original answer or it may have been modified by User B). So it goes:
User A→User B→User C

The only refinement that is looked at when calculating the accuracy for User A is the one done by User B. If User B chose to pass User A's answer without any modification then it counts as a 1. If User B chose to make any modification to User A's answer then it counts as a 0. And User A's accuracy is just the mean of all of the 0's and 1's aggregated over the batch.

Similarly User B's accuracy calculation would include a 1 or 0 based on whether User C passed User B's work exactly as it was or modified it. In this example there would be no impact on User C's accuracy calculation as User C's answer was never evaluated by another user.

By default, the system blocks users whose true accuracy is found significantly likely to fall below a default threshold value, say accuracy <=0.65. A key feature of the automated QA system is that the overall quality of the customer deliverable is held constant regardless of the value of this threshold, while cost and velocity (the total throughput of completed customer work over a fixed time period) are directly impacted. Increasing the blocking threshold for accuracy produces a reduction in cost but a decrease in velocity, as only higher quality users are allowed to work in the batch and their work will require less refinement overall but generally less work would be completed over a given window of time. Similarly decreasing the blocking threshold for accuracy results in increased cost but higher velocity which can be worthwhile if there is a tight deadline.

The system tests the null hypothesis that the user's true value accuracy is greater than or equal to a set threshold, say 0.65.
Null Hypothesis
   Ho: Accuracy >=0.65
Alternative Hypothesis
   Ha: Accuracy <0.65

The system computes a p-value for this test and if the p-value falls below 0.05 then the system rejects the null hypothesis in favor of the one-sided alternative that the user's true accuracy is in fact below the threshold and so the system blocks that user from completing any further tasks in the batch. The system calculates the p-value for this test as follows:
Let
   x=the total number of passes a user received
   n=the total number of refinements that the user received
   p=the minimum accuracy value that is allowed without blocking
Then

chi2_statistic=((|x−p*n|−0.5)̂2)/(p*n)+((|(n−x)−(1−p)*n|−0.5)̂2)/(n*(1−p))

z=sign(x/n−p)*sqrt(chi2_statistic)

p_value=CDF(z)
where CDF is the cumulative distribution function for the normal distribution.

Users are blocked on their accuracy in real time as they task in the system. If the threshold for blocking on accuracy is increased or decreased during the process all users blocking status is updated according to the new threshold. For example, the system may block a user by not assigning a user to a task, preventing the user from completing a task, and/or reassigning a task previously assigned to the user to another user that is qualified to complete the task.

### Job Progress Metrics

The system estimates the contribution that a particular user is making on a batch of tasks that they are working in. The first step in this process is computing the job progress metrics for each task that is submitted. To compute the job progress, each source answer and each refinement answer for a particular job is compared against the final (fully refined) answer that is submitted for the last refinement task on that job. Often a job contains many “annotations”, such as an image with multiple bounding boxes. In these cases the system is able to compute an overall score for each image using the formula:

$$Job Progress = \frac{correct\_annotations}{final\_annotations + excess\_annotations}$$

### Where

correct_annotations=number of annotations that were present that meet the capture criteria (defined below) when compared against the final annotations
excess_annotations=number of annotations that were present that were not matched to one of the final annotations
final_annotations=number of annotations that were present in the final annotation

The capture criteria is the rule that has been set for how “close” an annotation is to the final annotation in order to be deemed correct. The allowable distance could be in the form of a threshold on the intersection over union (IoU) metric, the Hausdorff distance, or the maximum allowable pixel deviation among others. Note that if there is only one annotation drawn, then the job progress will be binary.

### Example

[initial] job_progress=0.0 (no answer yet)
source-user: job_progress=0.52 (after the source job)
refine-user1: job_progress=0.58 (after the first refinement)
refine-user2: job_progress=0.98 (after the second refinement)
refine-user3: job_progress=0.98 (after the third refiner did nothing)
refine-user4: job_progress=1.0 (after the final refinement)
   Note that the job progress is not necessarily monotonically increasing in practice, as one refiner may take an action that moves the answer farther away from what will eventually be the final answer. Also note that a job always starts with initial job_progress=0.0 prior to any answer being collected, and by definition job_progress=1.0 for the final refinement. Note that job_progress values always fall in the range [0, 1].

### User Contribution

The contribution score for a user in a batch is an estimate of the actual contribution that the user is making to each job that they receive. Source users and refiners who consistently produce answers that are very good (and therefore typically pass all the way through refinement with little to no modification) are making a great contribution, while source users who provide poor answers and refiners who always pass everything they receive without making any improvements (so their answers will typically be modified significantly in later refinements) are not making a substantial contribution.

Each job can have a user contribution input and output pair. The job_progress scores that were computed above can now be used to form the input and output values that are used to calculate each user's contribution to that particular job. All users who touched the job have an input/output pair for that job except the final refiner whose work was never evaluated by another user.

### Example: (Following Same Numbers as Above)

user on job-user1: contribution_input=0.0, contribution_output=0.52
user on job-user2: contribution_input=0.52, contribution_output=0.58
user on job-user3: contribution_input=0.58, contribution_output=0.98
user on job-user4: contribution_input=0.98, contribution_output=0.98
user on job-user5: [nothing is computed]

A contribution parameter is a single number to summarize the typical contribution that a user is making over all of the jobs they have participated on. The contribution parameter for a user helps the system identify source users and refiners who are not making significant positive contributions to the answers they submit. For example, a poor refiner could simply click to pass all work or they could make only tiny modifications and pass it along. In those cases the user's accuracy may still be good if the work they were receiving was of good quality to begin with, so understanding the value of the actual annotations or modifications that a particular user has added helps to identify (and then block) any source or refinement users who do not contribute in a meaningful positive way toward successful completion of the task.

A user's contribution can be represented by a curve for each task set (source and refinement batch combined) that they participate in. This curve is estimated directly from the collection of contribution data points (input and output pairs) that have been collected for the user across the task set. Note that if a particular user worked in both the source and refinement batch then the system will pool all of their contribution data from both batches in order to estimate a single curve.

A user's contribution curve for a particular task set is parameterized by a single value, gamma, which is the y-intercept for the least squares line fit over their (input, output) pairs. The system reduces down to only the “informative pairs” which are all pairs with input <0.95. All pairs with input >=0.95 are removed prior to fitting the line as these data points provide very little information about the contribution that the user is making.

For any user with at least 10 informative pairs the system wishes to test the null hypothesis that the user's true value of gamma is greater than or equal to a set threshold, say 0.4. Note that in other embodiments, a larger number than 10 can be used.
Null Hypothesis
   Ho: Gamma >=0.4
Alternative Hypothesis
   Ha: Gamma <0.4

The system computes a p-value for this test using only the user's informative pairs. If the p-value falls below 0.05 then the system rejects the null hypothesis in favor of the one-sided alternative that the user's contribution parameter gamma is in fact below the threshold and so the system blocks that user from completing any further tasks in the batch. For example, the system may block a user by not assigning a user to a task, preventing the user from completing a task, and/or reassigning a task previously assigned to the user to another user that is qualified to complete the task.

The system calculates the p-value for this test using the following formula which is based on a linear regression line through all informative (input, output) pairs:
Let
   x=input values from informative pairs
   y=output values from informative pairs
Then

y_new=y−x

x_new=1−x

gamma=sum(y_new*x_new)/sum(x_neŵ2)

MSE=sum((y_new−x_new*gamma)̂2)/(length(x)−1)

SE=sqrt(MSE/sum(x_neŵ2))

t_value=(gamma−gamma_threshold)/SE

p_value=pt(t_value, df=length(x)−1, lower.tail=T)
where pt( ) is the probability function for the t-distribution

Finally, the system blocks the user from completing more tasks if:
p_value <0.05 AND the number of informative pairs is greater than 10

Note that having a very low p-value suggests that the system has strong evidence that this user is making a poor contribution in their tasking.

Note that users are blocked on their contribution parameter gamma in real-time as they task in the system. The current default value of 0.4 is used in the system, but this number can be modified if the system finds that the blocking is overly aggressive or too permissive.

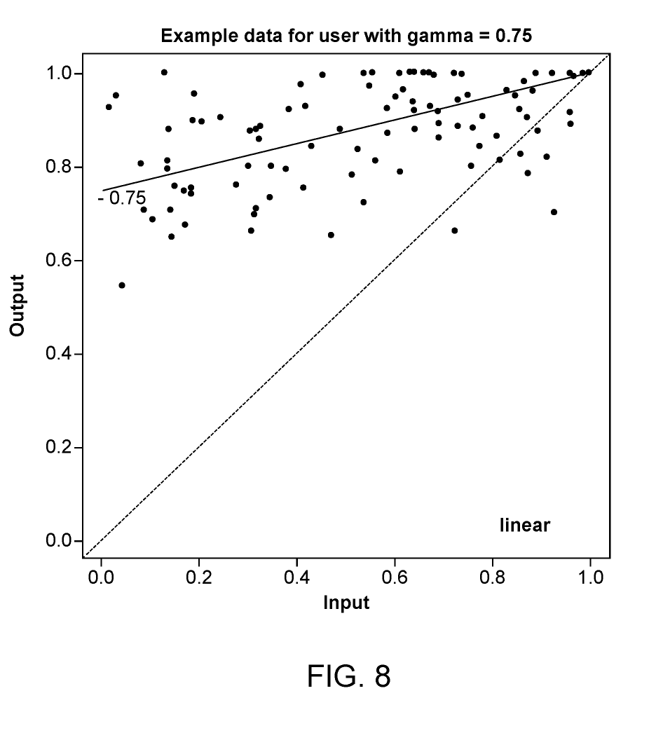

FIG. 8 shows an example of the linear functional form for the contribution parameter. An example calculation:

input_value=c(0.47, 0.21, 0.9, 0.01, 0.1, 0.33, 0.51, 0.8, 0.82, 0.96, 0.78, 0.36)

output_value=c(0.63, 0.21, 0.95, 0.46, 0.13, 0.64, 0.77, 0.8, 0.96, 0.96, 0.84, 0.72)

inverse_gamma_function(input_value, output_value, gamma_threshold=0.3)

gamma=0.297, p_value=0.483

### Stopping Rule

Each time a source job or a refinement is submitted, the system makes a decision about whether to send that answer to another refiner for further improvement or to stop refining and consider it finished. The number of refinement steps required is determined by a mathematical function that takes into account the accuracy and reliability of each of the individual users (source user and refinement users) who have participated on that job.

Start with an initial cap of max_refinements_per_job=6 for each job. The number six is used as a default, but a different number could be used. For example, it is possible to achieve many correct answers after 3.5 refinements. The number can be adjusted based on budget, time, or other factors. Note that the system does allow jobs to continue on with more than six refinements if refiners are continuing to make modifications to the answer.

As jobs progress through refinement the system iteratively updates the probability that the answer is correct based on the series of users who have touched the job and the actions they have taken. Note that in this embodiment, any user with fewer than 10 data points available for calculating their accuracy is given a default accuracy estimate of 0.4 (a conservatively low estimate) for the purposes of calculating any stopping rule criteria.

Let P(Correct) be the current estimate of the probability that an answer to a job is correct. Refinements continue until both of the following criteria are met:
P(Correct)>=the customer quality threshold
   OR
the number of refinements has exceeded the maximum number of refinements allowed (cap of max_refinements_per_job),
and
The most recent refiner made no modifications (they Passed the answer)

Note: The second criteria has been added to ensure quality for more complex jobs that may require more than the typical amount of refinement.

The probability that the current answer for a job is correct can be computed as follows:

$$\begin{matrix}P ( Correct ) = P ( Answer started out correct or has since \\ become correct ) \\ = 1 - P ( Answer has been wrong the whole time ) \\ = 1 - PROD ( User i supplies an incorrect answer ) \\ = 1 - PROD ( 1 - P ( User i supplies a correct answer ) ) \\ = 1 - PROD ( 1 - AA\_i )\end{matrix}$$

where AA_i is the adjusted accuracy for user i and PROD is the product over all terms.
   Note that in this formula the system continues to use the binary definition of correctness, so an answer that is mostly right is still considered “incorrect” for these purposes.

### Adjusted Accuracy and Precision

The usual accuracy estimate described in earlier sections is actually a biased estimate of the true probability that any answer provided by a given user is correct. It is biased because the system knows that the refiners who have evaluated the user's work sometimes make mistakes in their assessments. A refiner may make a modification to an answer when in fact the answer was acceptable by customer standards, or a refiner may fail to make a modification even when an obvious error exists.

The accuracy estimate for a user is just the pass rate, but what the system uses when updating the stopping rule calculation of P(correct) for a job is a true probability that the answer provided by the user is correct. The accuracy estimate is called the adjusted accuracy.

The system can estimate P(an answer is correct the refiner passed it) for each refiner who passed any job that the target user completed. If the system further make the conservative assumption that P(an answer is correct the refiner modified it)=0.0 for any refiner who modified (“failed”) this user's work then the system can aggressively adjust for the bias present in the accuracy estimate for this user. In order to make the bias correction adjustment the system estimates P(an answer is correct the refiner passed it) for each refiner. Consider the following 2×2 confusion matrix for a given refiner:

| | Answer | Answer |
|---|---|---|
| | Correct | Incorrect |
| Passed | A | B |
| Failed (Modified) | C | D |

Then let precision=P(correct|passed)=A/(A+B)

Suppose the system wants to estimate the precision for a particular refiner. The system can identify the set of all jobs that this refiner passed that were later refined by another user. In these cases both refiners looked at the identical answer, so the system can examine the proportion of answers that the target refiner has passed that were subsequently also passed by the next refiner.

$$Precision = \frac{\# Jobs they Passed that were also Passed by next refiner}{\begin{matrix}\# Jobs they Passed that \\ received at least one more refinement\end{matrix}}$$

Once a precision estimate is calculated for each refiner, then the system can conservatively adjust the accuracy estimate for any given source or refinement user by replacing the value 1.0 in the numerator for any passing job with the estimate of the precision of the refiner who passed that job.

$$Adjusted Accuracy = \frac{sum [ was\_passed * Precision\_of \_refiner \_who \_received \_it ]}{num\_jobs \_evaluated}$$

where was_passed is a binary indicator variable that represents whether the refiner who received the job passed it or not.

### Updating the Value of P(Correct) in the Stopping Rule

An important property of the P(Correct) in the stopping rule calculation is that it can be computed and updated iteratively without having to keep track of each of the individual estimates of user accuracy as the job progresses through refiners. In one embodiment, the system only keeps track of the current estimate of P(Correct) coming out of the last step which simplifies the implementation. Above it was stated that when calculating the probability that a given answer for a job is correct is: P(Correct)=1−PROD(1−AA_i), where AA_i is the adjusted accuracy of the i^{th} user to touch the job.

In practice, each time the system chooses to add one more refinement to a job then in order to update the P(Correct) after that new refinement the system applies an additional term of the form (1−P_i) to the product above. In fact a formula can be derived to allow the system to directly update P(Correct) in an iterative fashion given only the previous value of P(Correct) and the adjusted accuracy of the new refinement user. Suppose before adding the new refinement the value is:

P(Correct)=1−[PROD from 1 to k of (1−AA_i)]

Then

[PROD from 1 to k of (1−AA_i)]=1−P(Correct)

Now suppose the system adds one more refinement so the system adds one more term to the product in order to update the value of P(Correct). Multiplying on both sides by the new term (1−AA (i+1)) gives

[PROD from 1 to k+1 of (1−AA_i)]=(1−P(Correct))*(1−AA_(k+1))

and so to move to the form of the original formula, the result is:

1−[PROD from 1 to k+1 of (1−AA_i)]=1−(1−P(Correct))*(1−AA_(k+1))

More succinctly, this is:

Updated P(Correct)=1−(1−P(Correct))*(1−AA_(k+1))

Note that the system only uses the actual estimate of user accuracy for a user once the system has enough data points to create a stable estimate. The system uses a conservative (low) default accuracy estimate of 0.4 for any new users in the batch and then move to using the individual accuracy estimate after at least a certain number (e.g., ten) of the user's jobs have been evaluated through refinement.

### Calibration in the Source and Refinement Batches

Before completing any customer work in a batch, a use first successfully passes a set of “calibration” jobs. These calibration jobs are served in a random order for each user and they appear identical to actual customer tasks in the batch, but in fact the correct answers are known ahead of time. Both source batches and refinement batches have calibration jobs at the beginning. Any user who is unable to pass the appropriate proportion of calibration questions at the beginning of a batch will be blocked from completing any customer work.

### Pass Rate Blocking

As an added protection, the system blocks any refiners who pass answers without modification at a very high rate compared to other refiners in that batch. For example, to do this, the system computes the pass rate for each refiner and then blocks any user who has done at least 30 refinement jobs and whose pass rate falls in the top 5% of all refiners who have worked in this batch.

### Pending Refinement

If a user has too many jobs waiting to get the next layer of refinement, then the user will be “throttled” or paused from continuing to work until the refinements catch up. This prevents users from racing ahead before the system has enough data on the quality of their work.

### Adding More Refinement

The system provides internal system administrators with the ability to add any additional refinement as needed in two ways: (1) Add one more layer of refinement to every job in a batch. This is a powerful tool that allows the system administrator to increase the quality metrics over an entire batch if they find that the deliverable was not up to the agreed upon customer quality requirement. (2) Add one more layer of refinement to a single job. This can be used when the system administrator sees an error in the job and wants to fix it up.

### Recursive Batches

Task refinement works well for what is called “recursive batches” as well. Recursive batches are jobs that are too complex or time consuming for a single user to complete in one pass, and so the system breaks the job up into smaller identical tasks. For example, rather than asking the source user to box every car in an image (which could contain an entire parking lot full of cars) the system might ask each user to “box up to three cars” and then assemble the full answer iteratively.

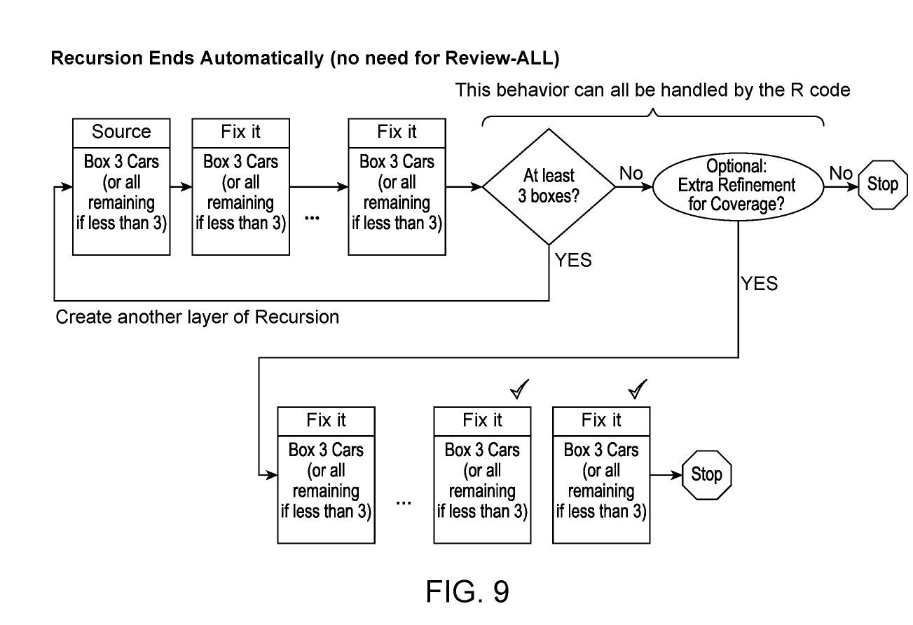

For example, a recursive task could have the following Source Question: Box exactly 3 cars (or box all remaining cars if there are less than 3). In task refinement this type of recursion on an image can finish automatically whenever one layer of the recursion has completed with less than 3 total boxes in it (after completing all necessary refinement steps for that layer). FIG. 9 depicts one example of task refinement with a recursive task.

For example, suppose there were 5 cars in the original image. The system could expect to obtain one source job with exactly 3 cars boxed plus one source job with exactly 2 cars boxed. When the second source job ends with just two boxes after passing all the way through refinement then the system knows that the task is complete. Note this recursion could also end with a job containing no boxes if all boxes had already been captured in the last pass.

### “Task Tips” Feedback: Explicit and Inferred

The quality of a particular user's work will be assessed through both explicit and inferred information the system obtains through the refiner who immediately follows the particular user on the job.

The system has the ability to collect quality data through direct questions that are asked of the refiner before they make any improvements on the answer. These answers can be used to directly identify the task tips that should be presented back to the previous user in order to improve the quality of their answers in the future. Task tips are the individual instructional panels associated with each of the specific questions that refiners are being asked. For example, in a particular batch a refiner may be asked, “Are the bounding boxes precise?” If a user is consistently evaluated as being imprecise then they will begin to see the task tip popup with the instructional panel explaining how to ensure that bounding boxes are precise.

The system also has the ability to automatically identify specific types of errors that users are making consistently through automatic examination of the modifications that refiners make after the user submits their jobs. For example, if subsequent refiners are routinely modifying the label aspect of the annotations that the user has provided, then it would suggest that the user sees the task tip that describes how to apply appropriate labels. Inferred quality metrics are computed following the same methods described in the contribution scoring section above.

### Extension to Semi-Automated Generated Annotations

An important extension of the task refinement process is that refinement can be applied to automatically generated annotations, or any annotation that is pre-generated by other means. For example, suppose the system applies an object detection algorithm to a set of images and the output is a collection of automatically generated bounding boxes around each of the vehicles in the images. There will likely be errors in the automatically generated bounding boxes (e.g., missed vehicles, objects captured that were not actually vehicles, imprecise box edges). These automatically generated bounding boxes can be passed to users for refinement.

For example, the system can first pass the automatically generated annotations to a broad set of “source” users who are asked to do the heavy lifting of correcting any errors in the annotations (e.g., fix the bounding boxes). Once the source user has made their modifications then their modified annotations are passed through a series of refiners just as they would be in the original task refinement process. The benefit to using semi-automated annotations is the reduction in total human time required to produce high quality annotations.

In an example workflow, the system uses a machine learning model to automatically draw bounding boxes around vehicles in an image, knowing that there may be some errors and omissions in these annotations. In the source batch, the system asks users to fix any errors that they see in the image: correct any automatically generated bounding boxes if needed, remove boxes that do not capture vehicles, and add boxes if any vehicles were missed. In the refinement batch, the system asks refiner users (higher quality users) to further refine the set of annotations to ensure they are correct. This same workflow can be used to refine any collection of automated or otherwise pre-generated annotations.

### Tasking System UI

The user interface (UI) has specific features to facilitate the segmentation of images. For example, it uses shared outlines, showing prior work, directionality of images, and a configurable toggle button.

### Shared Outlines

After the first object is outlined the user is able to utilize the outlines they have already created around one object to build outward from that object. For example, if a user sees two cars, one overlapping the other within the image, they are able to draw a first outline around the first car, and then use the portion of the outline which divides the two cars to build the outline around the second car. There is no need for the user to redraw the outline of the second car where it touches the first car since that outline has already been drawn. This feature enables users to segment an image with a great degree of both precision and efficiency. This feature allows the system to avoid a great deal of effort that would otherwise have to be needlessly duplicated.

### Showing Prior Work

When progress is passed from one user to another the system is able to display the outlines and labels created by the prior user in a way that enables the latest user to both see and use the prior outlines. Prior outlines are not editable by the subsequent users until the final improvements stage of the process, but users are able and encouraged to begin new outlines from existing lines.

### Azimuth Indicator/Manipulator

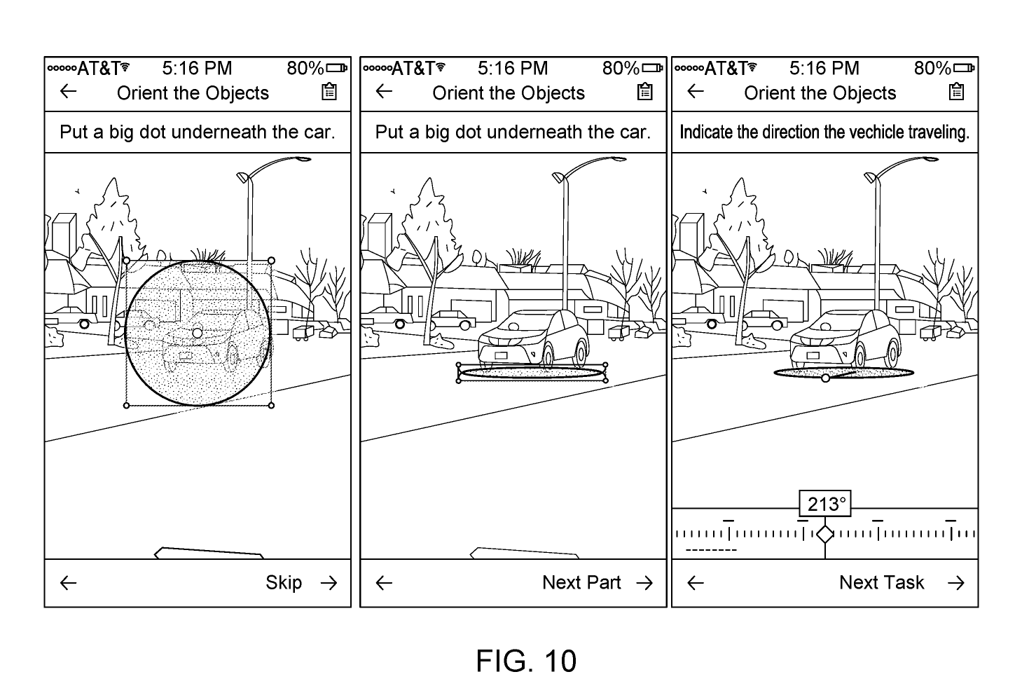

This disclosure further includes a UI which would allow users to indicate an object's orientation within an image as though that object were in a three dimensional (3D) space. The user is asked to first place and transform an ellipse so that it appears to be on the ground underneath an object within the image (e.g., a car, or pedestrian, etc.). The user is then asked to indicate the direction in which the object is heading by either moving a dot along the edge of the ellipse or manipulating an azimuth control which allows greater precision of angle placement. An example of this UI interface is shown in FIG. 10.

There are a few ways the ellipse could be positioned at the base of the car. The general idea is that a user would be instructed to squash (i.e., “non-uniformly scale”) the circle down into an ellipse that makes it look like the circle is painted on the road surface itself. This is a simple manipulation where the height of the circle is simply reduced though the width remains the same. To make look even more believable to a user, the circle can be positioned in z-order underneath a layer which has the car cut out from the background of the image so that the circle looks like it's actually painted on the road underneath the car.

Regarding how to determine the directionality of the object (whether a car or human or other movable object) the system would instruct the users to look for hints throughout the image as to the object direction and then manipulate the angle of direction either by the azimuth control, or by grabbing and moving the line, or by moving the dot around the ellipse on the ground. The system would instruct the user to line up the interactive dashed line parallel to the dashed lines of the road. In the case of a pedestrian, the system may ask a user to align the angle of the line with the perceived path of the pedestrian to indicate where the pedestrian would be three seconds from now if the pedestrian kept walking in the exact same direction.

In one embodiment, the system allows a user to place an ellipse on the ground of the image underneath the object and to indicate the directionality of the object with some kind of angle control. In another embodiment, an image processing system can use a series of frames to determine object placement within each frame. Based on the direction the object is moving relative to the successive frames, the system may manipulate the angle and azimuth control relative to the successive frames to determine relative direction.

### Configurable Toggle Button

When a customer (or user) is reviewing an annotation result from the system there are many different layers of information that could potentially be present on any given image. For example if a customer ran even the simplest of tasks (bounding boxes), the customer may want the ability to turn the boxes on and off in order to see whether the box is in the right place and whether everything is correct or not. On top of the boxes the customers may turn the labels on and off within the image. In addition to that, different customer reviewers of the annotations may leave notes related to different portions of the image. This is all for the simplest of annotation types, but the system may have task packs that include multiple types of annotations and customers could be able to turn on and off the polylines while leaving the bounding boxes right where they are. In another example, a customer or user can toggle on and off different classes (e.g., vehicles, pedestrians) to view a particular class.

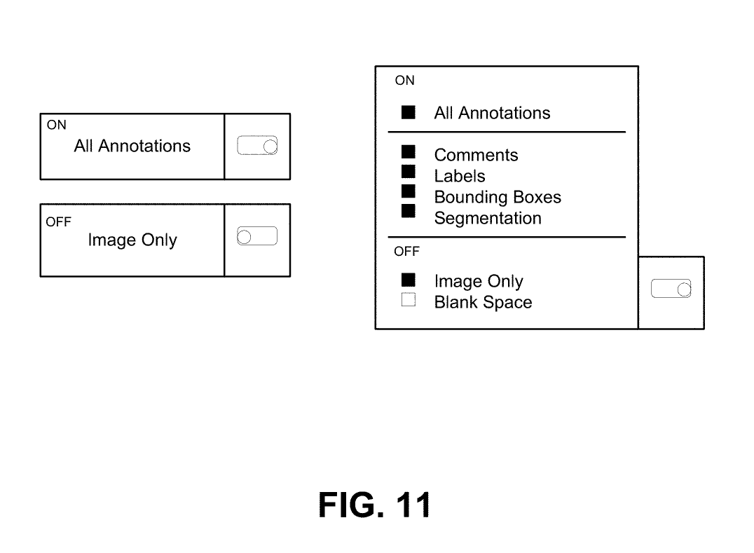

There are a fairly wide variety of things to show or hide, but the system may want customers to be able to toggle certain things on and off quickly as they look through images. If turning off all the annotations except for bounding boxes requires several clicks, the customers would not like having to make those same clicks over and over in order to be able to toggle between the views of interest to them. Disclosed is a way for customers retain an array of options for what gets turned on and off while keeping the simplicity of a single place to click in order to toggle back and forth between different states of visibility. For example, one customer may want to configure the toggle so that the original image is turned off and the bounding boxes and polylines are on between clicks. Another customer may want to turn off everything except for the image with the toggle. Both these cases can be done with the use of a configurable toggle as illustrated in FIG. 11.

### Other Features

Other features the system may support are: the ability to back out work done by a certain person within the process, knowledge about how or when points are snapped, and logic around whether users are allowed to cross lines or not and when more details are provided herein.

### Example Algorithms

Below is a detailed technical description regarding terms used in the segmentation process and examples of algorithms configured for use with the system disclosed herein. The example computing algorithms include: polygon walk, polygon merger, and hole patcher.

A polygon is represented by a list of dots and may be a closed shape. A dot may be a polygon vertex. A dot has an identifier called a “dot id”, and an x,y coordinate that represents its position. A segmentation mask may be a collection of polygons that share lines and dots in regions where they border each other. A valid segmentation mask contains no holes or crossing lines. A dot adjacency list may be a data structure in which each dot in the segmentation mask is stored under each dot it is directly connected to. This allows fast lookup of connections for a polygon walk. A polyline may be a list of dots that forms an unclosed polygon. An active polyline may be a line that has been drawn by the user, but that is not yet part of the segmentation mask. A set of active polylines are incorporated into the segmentation mask via the polygon walk algorithm. An island may be a stand-alone polygon that does not share any dots with any other polygon. A clump may be a group of connected polygons that, as a group, are not connected (i.e., share dots with) any polygons outside of the group. For example, a clump could be created by subdividing an island polygon. A hole may be an area of the image not included in any polygon. A valid segmentation mask should not have any holes within its bounds.

### Polygon Walk

This is one example of a polygon walk that assumes all active polylines will eventually be used when a polygon is next made. When a user subdivides a polygon that is embedded in a segmentation mask, the system determines if a valid set of new polygons was created, and if so, splits that polygon into the two new polygons. This is accomplished with the “polygon walk” algorithm, which does the following:
1) Build a “dot adjacency list”, from the current segmentation mask.
2) Add all active polylines other than the most recent one to the dot adjacency list.
3) Attempt to walk the polygon in both a clockwise and counterclockwise direction.
4) If this results in two valid, nonequivalent new polygons, add these to the segmentation mask and delete the old polygon that was subdivided.

### Walking in a Direction (Clockwise or Counterclockwise)

This is one example of walking in a direction (either clockwise or counterclockwise) which is accomplished by the following steps:
1) Create a new list of dots (call it the “new dots list”) that will represent the new polygon. Add the most recent active polyline to it.
2) The “current line” is the line segment that starts at the second-to-last item in the “new dots list” and ends at the last item in the “new dots list”.
3) Use the dot adjacency list to look up all dots connected to the end dot of the current line.
4) Find the difference in angle between each connected dot and the current line.
5) The “turn” the system takes will be toward the connected dot with the smallest or largest difference in angle depending on if the system is going clockwise or counterclockwise.
6) Add the chosen connected dot to the end of the “new dots list”.
7) Repeat steps 3 through 5 until
   a. The system chooses a connected dot that is the same as the first dot in the “new dots list”. When this occurs, the dot is not added to the list. The directional polygon walk is complete, and the “new dots list” represents the successfully created new polygon.
   b. The system chooses a connected dot that is the same as the last dot in the most recent active polyline. This means the polygon walk is finished and no valid polygon has been found.

### Polygon Merger

Polygon merging has several uses in segmentation. Polygon merging can fix damage from fraud by merging adjacent polygons with the same tag, absorb small untagged regions by combining them with the largest adjacent polygon, and support merging pre-computed super pixels that the user paints with the same tag. To merge two polygons:
1) Find all the lines in the segmentation mask that are used in either polygon.
2) From those, find all the lines that are used in either but not both of the two polygons to merge.
3) These lines can be arranged end-to-end according to their existing connections to construct the new polygon that can replace the two being merged.
4) Delete the two polygons being merged, and add the new polygon.

### Hole Patcher

A segmentation mask should ideally not have any “holes” (that is, an area of the image that is not part of any polygon). Having a hole patcher is an important tool to safeguard data quality in the event of an error. To find and patch a hole:
1) Find all lines that are only used in one polygon
2) Arrange these lines end-to-end using their existing connections. This will result in potentially multiple lists of dots, each one of which represents an “edge”. These may be the edges of islands, clumps, holes, or the edges of the segmentation mask itself.
3) Distinguish the edges of holes from these other possibilities because all holes (and only holes) will have at least one connection to a dot that is not inside of the shape made by the edge.
4) The list of dots that represents the edge of a hole can then be used to create the polygon that can patch the hole.

### Example Semantic Segmentation for Autonomous Vehicle AI

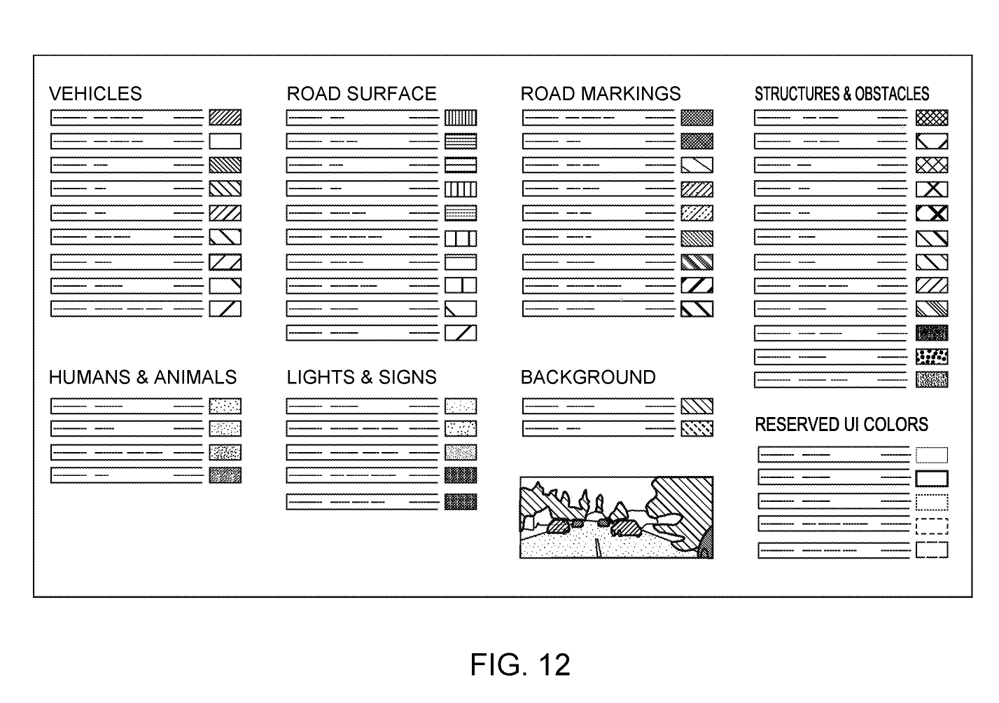

The artificial intelligence (AI) that enables autonomous driving requires large amounts of specialized training data. Users can complete paid graphical game-like tasks to create semantic segmentation masks to teach a system to see what humans see to build its predictive capabilities. The system breaks complex tasks into multiple task streams, instruction sets, comparison to known answers or ground truth, and quality assurance cycles. In the example shown in FIG. 12, over 60 classes of terrain, road, vehicle, pedestrian, and vegetation and signage features needed to be segmented with pixel-level accuracy.

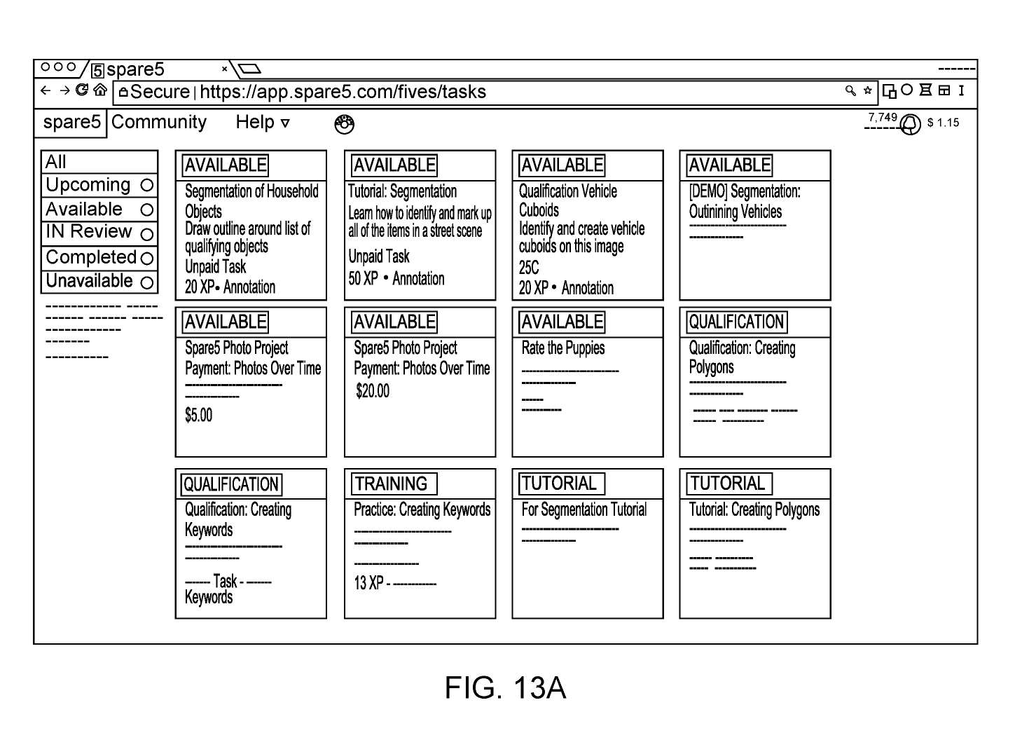

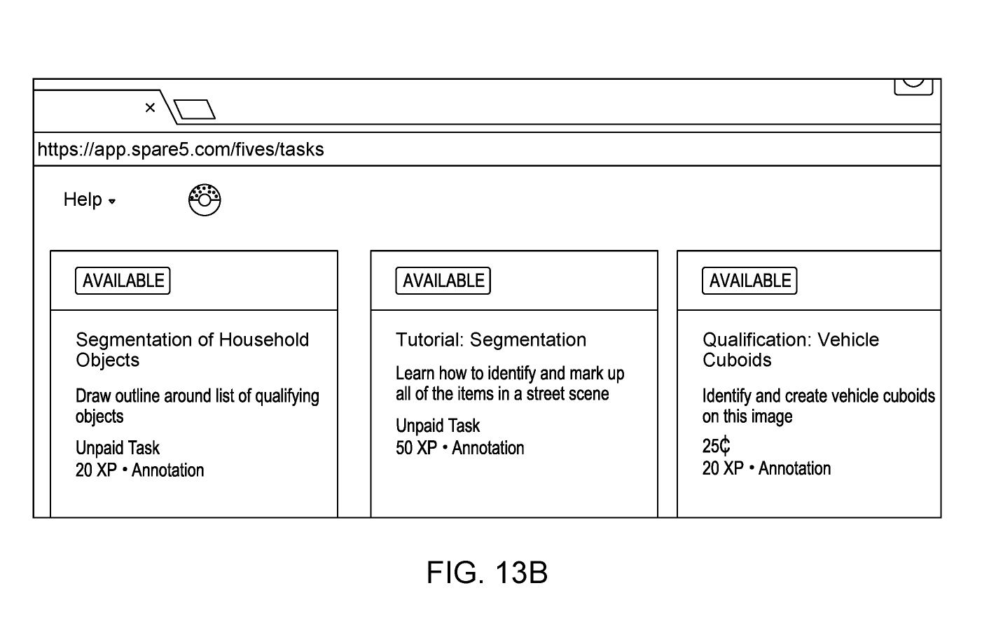

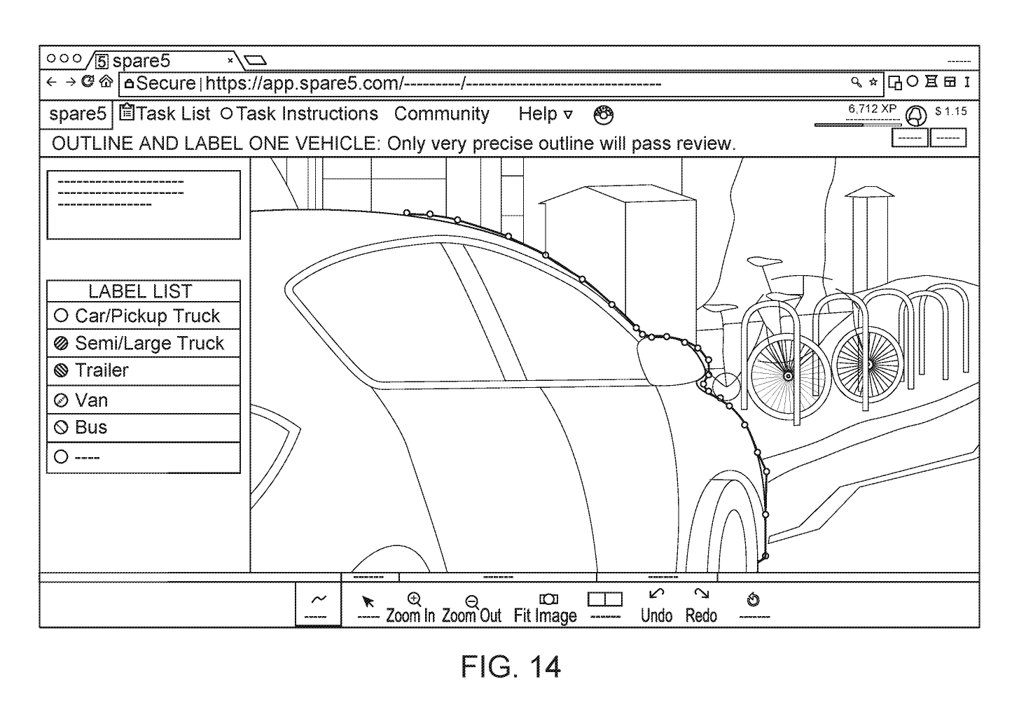

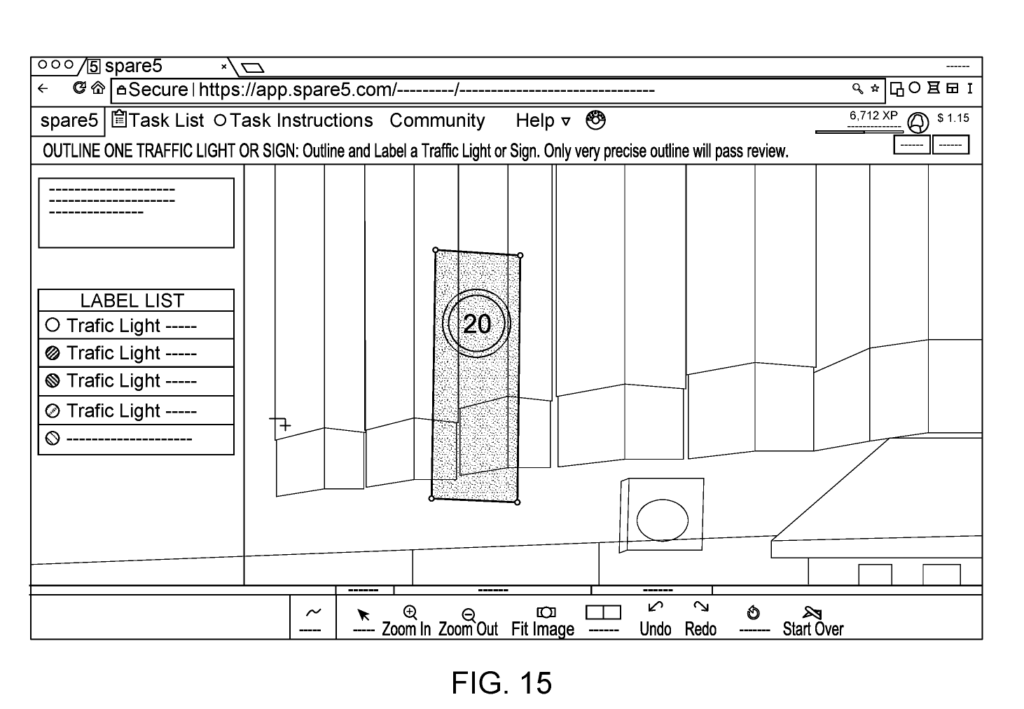

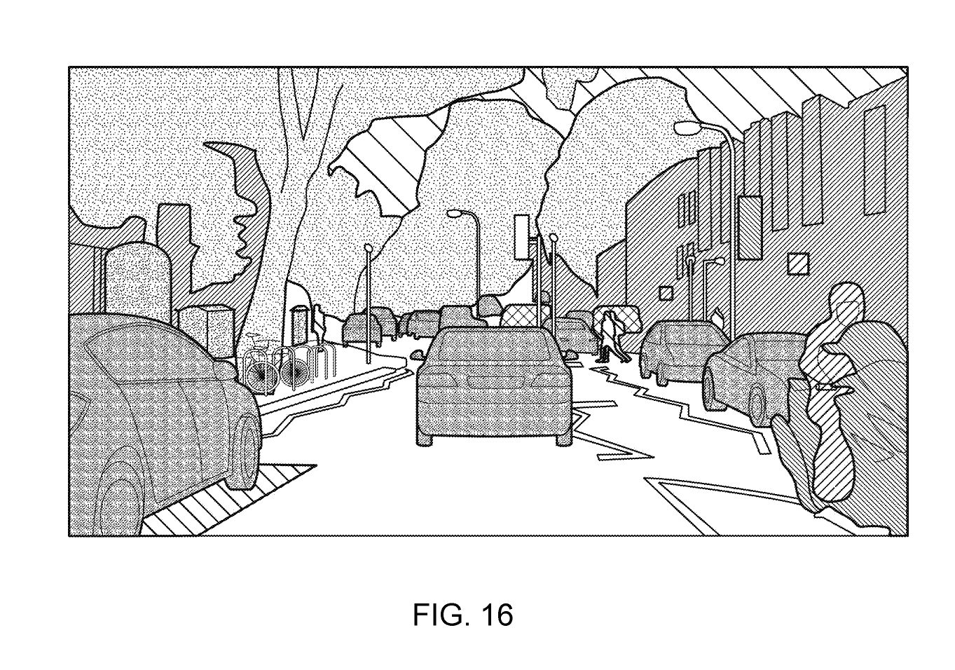

Qualifying users demonstrate consistently excellent performance on autonomous vehicle computer vision tasks by training on the system and then qualifying for paid tasks. FIGS. 13A and 13B show examples of the user interface shown to users of the system regarding training tutorials, qualification, and tasks. The trained users (e.g., trained specialists) complete the semantic segments of complex images in stages to simplify the task for the user and improve overall accuracy and production speed for the task. The trained users complete tasks such as outlining a single vehicle, as shown in FIG. 14. In later stages, the same workflow is applied to pedestrians, buildings, structures, street signs, markers, road surfaces, etc., until the entire scene is segmented. For example, FIG. 15 shows a sign being outlined. A quality assurance process (e.g., task refinement) combines human review with machine learning to ignore work that does not meet quality customer standards. All workflows are combined by a final data export process. FIG. 16 shows a finished result. The finished result is a semantic segmentation that meets challenging autonomous vehicle requirements at scale.

### Example Machine Architecture

The processes and modules described herein may be done on a computer system, as shown in FIG. 17. FIG. 17 is a block diagram illustrating components of an example machine able to read instructions from a machine-readable medium and execute them in a processor (or controller). Specifically, FIG. 17 shows a diagrammatic representation of a machine in the example form of a computer system 1700. The computer system 1700 can be used to execute instructions 1724 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 1724 (sequential or otherwise) that specify actions to be taken by that machine. Further, while only a single machine is illustrated, the term “machine” shall also be taken to include any collection of machines that individually or jointly execute instructions 1724 to perform any one or more of the methodologies discussed herein.

The example computer system 1700 includes one or more processing units (generally processor 1702). The processor 1702 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 1700 also includes a main memory 1704. The computer system may include a storage unit 1716. The processor 1702, memory 1704 and the storage unit 1716 communicate via a bus 1708.

In addition, the computer system 1706 can include a static memory 1706, a display driver 1710 (e.g., to drive a plasma display panel (PDP), a liquid crystal display (LCD), or a projector). The computer system 1700 may also include alphanumeric input device 1712 (e.g., a keyboard), a cursor control device 1714 (e.g., a mouse, a trackball, a joystick, a motion sensor, or other pointing instrument), a signal generation device 1718 (e.g., a speaker), and a network interface device 1720, which also are configured to communicate via the bus 1708.

The storage unit 1716 includes a machine-readable medium 1722 on which is stored instructions 1724 (e.g., software) embodying any one or more of the methodologies or functions described herein. The instructions 1724 may also reside, completely or at least partially, within the main memory 1704 or within the processor 1702 (e.g., within a processor's cache memory) during execution thereof by the computer system 1700, the main memory 1704 and the processor 1702 also constituting machine-readable media. The instructions 1724 may be transmitted or received over a network 1726 via the network interface device 1720.

While machine-readable medium 1722 is shown in an example embodiment to be a single medium, the term “machine-readable medium” should be taken to include a single medium or multiple media (e.g., a centralized or distributed database, or associated caches and servers) able to store the instructions 1724. The term “machine-readable medium” shall also be taken to include any medium that is capable of storing instructions 1724 for execution by the machine and that cause the machine to perform any one or more of the methodologies disclosed herein. The term “machine-readable medium” includes, but not be limited to, data repositories in the form of solid-state memories, optical media, and magnetic media.

### Additional Considerations

The application as disclosed provides benefits and advantages that include enabling computer automation for accurately assessing the completion of tasks for solving large data problems. Tasks done by human users have a subjective element to them that requires determining if a task is completed properly. The disclosed configurations assess accuracy of those tasks in an automated manner that allows for follow up adjustments to minimize or reduce issues of subjectivity. For example, by viewing a completed task accuracy may be evaluated based on expected results that is automatically accessed, for example, such as whether a bounding box is appropriately drawn to outline an object in an image. In one example, the disclosed configuration beneficially discloses an automated process for computers to determine if tasks are completed accurately in a different way than human users would. Rather than subjectively assessing the accurate completion of a job, the application describes determining if a job is completed accurately by computing a probability that the answer of the job is correct based on one or more user accuracies of the users that worked on the job.

The application also allows automated distribution of tasks to users. For example, the disclosed configuration automatically analyzes the task to be completed and determines how best to match to a user to ensure highest likelihood of accuracy by evaluating a user accuracy or a user contribution score for previous tasks. Thus, the disclosed configuration beneficially increases the speed and the accuracy at which tasks are completed in a computing environment. In one example, user accuracy and the user contribution score are beneficially computed based on information collected by the tasking system. For example, the tasking system tracks and stores information about each annotation made by a user in an image and assigns a value to subsequent analysis in determining future task to assign. The tasking system can then leverage such stored historical information to improve upon how jobs are distributed and how a completed job can be accessed for accuracy.

Further, the application allows for automated segmentation of images. For example, the described configuration enables creation of large data sets of accurately segmented images. The described configuration produces data (e.g., segmented images) that have outlined shapes within an image where the accuracy of the outlined shape is confirmed and the outlined shapes are appropriately labeled (e.g., automobile, utility pole, road). The configuration can then learn from these large data sets (e.g., use these data sets as inputs to a machine-learning model) to automatically segment images. The configuration can pre-segment a current image into polygons (e.g., outlined objects) and automatically identify the polygons in the current image based on the information from the previously stored data set which includes accurately labeled polygons and context in the image (e.g., the shape or placement of a polygon on a road indicates it is an automobile) to accurately label the polygons.

The application also allows directionality of an object in an image to be automatically determined. For example, a direction an object (e.g., car) is traveling in an image can be determined based on a series of captured frames associated with the image. The identification of the same object in different frames with a timestamp can be used to automatically determine the direction the object is traveling.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated in the FIGS. 1-17. Modules may constitute either software modules (e.g., code embodied on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 1702, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for determining computerized tasks in a task batch for assignment to a plurality of entities and assessing the accuracy of the completed tasks through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for segmenting an image, the method comprising:
determining multiple tasks for segmenting the image;
for each task:
assigning a particular user of a plurality of users to work on a task based on an accuracy or a computed contribution score of the particular user,
receiving an indication of a completed task from the particular user, and
assessing an accuracy of the completed task based on the accuracy of the user;
for each user, including the particular user, of the plurality of users:
computing an accuracy of a user of the plurality of users based on a number of previously completed tasks by the user that did not require modification by another user and a number of previously completed tasks by the user that were assessed for accuracy, and
computing a contribution score of the user based on an input job progress metric and an output job progress metric of the previously completed tasks by the user that were assessed for accuracy, wherein a job progress metric is based on annotations made by the user in the previously completed tasks by the user that were assessed for accuracy and final annotations in corresponding accurately completed tasks; and
combining, responsive to determining all multiple tasks are completed accurately, the completed multiple tasks to form a segmented image.

2. The method of claim 1, wherein the input job progress metric is based on (i) a number of annotations made by the user in a previously completed task meeting a capture criteria to final annotations of a corresponding accurately completed task, (ii) a number of annotations made by the user in the previously completed task not meeting the capture criteria compared to the final annotations of the corresponding accurately completed task, and (iii) a number of annotations present in the final annotations of the corresponding accurately completed task.

3. The method of claim 1, wherein the output job progress metric is based on (i) a number of annotations made by the user in a previously completed task meeting a capture criteria to final annotations of a corresponding accurately completed task, (ii) a number of annotations made by the particular user in the previously completed task not meeting the capture criteria compared to the final annotations of the corresponding accurately completed task, and (iii) a number of annotations present in the final annotations of the corresponding accurately completed task.

4. The method of claim 1, wherein at least one task includes presenting, to at least one user, a user interface that includes a user interface (UI) control in a shape of an ellipse and an azimuth control on an edge of the ellipse, wherein the UI control is configured to allow the at least one user to move the ellipse to appear underneath an object within the image and the azimuth control is configured to allow the user to move the azimuth control along the edge of the ellipse to indicate a direction in which the object is heading.

5. The method of claim 4, wherein the azimuth control indicates the direction in which the object is heading based on a series of captured frames associated with the image.

6. A computer program product stored on a non-transitory computer-readable storage medium comprising stored executable computer program instructions for segmenting an image, the computer program instructions when executed by a computer processor cause the computer processor to:
determine multiple tasks for segmenting the image;
for each task:
assign a particular user to work on a task based on an accuracy or a contribution score of the particular user,
receive an indication of a completed task from the particular user, and assess an accuracy of the completed task based on the accuracy of the particular user;
for each user including the particular user, of a plurality of users:
compute an accuracy of a user based on a number of previously completed tasks by the user that did not require modification by another user and a number of previously completed tasks by the user that were assessed for accuracy, and
compute a contribution score of the user based on an input job progress metric and an output job progress metric of previously completed tasks by the user that were assessed for accuracy, wherein a job progress metric is based on annotations made by the user in the previously completed tasks by the user and final annotations in corresponding accurately completed tasks; and
combine, responsive to determining all multiple tasks are completed accurately, the completed multiple tasks to form a segmented image.

7. The computer program product of claim 6, wherein the input job progress metric is based on (i) a number of annotations made by the user in a previously completed task meeting a capture criteria to final annotations of a corresponding accurately completed task, (ii) a number of annotations made by the user in the previously completed task not meeting the capture criteria compared to the final annotations of the corresponding accurately completed task, and (iii) a number of annotations present in the final annotations of the corresponding accurately completed task.

8. The computer program product of claim 6, wherein the output job progress metric is based on (i) a number of annotations made by the user in a previously completed task meeting a capture criteria to final annotations of a corresponding accurately completed task, (ii) a number of annotations made by the particular user in the previously completed task not meeting the capture criteria compared to the final annotations of the corresponding accurately completed task, and (iii) a number of annotations present in the final annotations of the corresponding accurately completed task.

9. The computer program product of claim 6, wherein at least one task includes presenting, to at least one user, a user interface that includes a user interface (UI) control in a shape of an ellipse and an azimuth control on an edge of the ellipse, wherein the UI control is configured to allow the at least one user to move the ellipse to appear underneath an object within the image and the azimuth control is configured to allow the at least one user to move the azimuth control along the edge of the ellipse to indicate a direction in which the object is heading.

10. The computer program product of claim 9, wherein the azimuth control indicates the direction in which the object is heading based on a series of captured frames associated with the image.

11. An online system configured for segmenting an image, the online system configured to:
determine multiple tasks for segmenting the image;
for each task:
assign a particular user to work on a task based on an accuracy or a contribution score of the user,
receive an indication of a completed task from the particular user, and
assess an accuracy of the completed task based on the accuracy of the user;
for each user, including the particular user, of a plurality of users:
computing an accuracy of a user based on a number of previously completed tasks by the user that did not require modification by another user and a number of previously completed tasks by the user that were assessed for accuracy, and
computing a contribution score of the user based on an input job progress metric and an output job progress metric of previously completed tasks by the user that were assessed for accuracy, wherein a job progress metric is based on annotations made by the user in the previously completed tasks by the user and final annotations in corresponding accurately completed tasks; and
combine, responsive to determining all multiple tasks are completed accurately, the completed multiple tasks to form a segmented image.

12. The online system of claim 11, wherein the input job progress metric is based on (i) a number of annotations made by the user in a previously completed task meeting a capture criteria to final annotations of a corresponding accurately completed task, (ii) a number of annotations made by the user in the previously completed task not meeting the capture criteria compared to the final annotations of the corresponding accurately completed task, and (iii) a number of annotations present in the final annotations of the corresponding accurately completed task.

13. The online system of claim 11, wherein the output job progress metric is based on (i) a number of annotations made by the user in a previously completed task meeting a capture criteria to final annotations of a corresponding accurately completed task, (ii) a number of annotations made by the particular user in the previously completed task not meeting the capture criteria compared to the final annotations of the corresponding accurately completed task, and (iii) a number of annotations present in the final annotations of the corresponding accurately completed task.

14. The online system of claim 11, wherein at least one task includes presenting, to at least one user, a user interface that includes a user interface (UI) control in a shape of an ellipse and an azimuth control on an edge of the ellipse, wherein the UI control is configured to allow the at least one user to move the ellipse to appear underneath an object within the image, wherein the azimuth control is configured to allow the at least one user to move the azimuth control along the edge of the ellipse to indicate a direction in which the object is heading.

15. The online system of claim 14, wherein the azimuth control indicates the direction in which the object is heading based on a series of captured frames associated with the image.
